(19) United States
(12) Patent Application Publication
(10) Pub. No.: US 2013/0266912 A1
(43) Pub. Date: Oct. 10, 2013

(54) DENTAL IMPLANT

(71) Applicants: Amos Ben-yehouda, Zur-Hadassa (IL); Nir Ben-Chetrit, Modi'in (IL); Gabriel Ben-Chetrit, Jerusalem (IL)

(72) Inventors: Amos Ben-yehouda, Zur-Hadassa (IL); Nir Ben-Chetrit, Modi'in (IL); Gabriel Ben-Chetrit, Jerusalem (IL)

(21) Appl. No.: 13/438,883

(22) Filed: Apr. 4, 2012

(51) Int. Cl. A61C 8/00

(52) U.S. Cl. 433/174

(57) ABSTRACT

A dental implant, that may include an elongated body; a top element that is arranged to be on top of an upper portion of a bone when a lower portion of the elongated body is implanted in the bone; wherein the elongated body has a longitudinal axis and is connected to the elongated body; wherein an outer edge of the top element is more distant from the longitudinal axis that any outer edge of the elongated body; at least one structural element, connected to the elongated body, wherein that at least one structural element defines a substantially spiral path outside of the elongated body; wherein a radius of the substantially spiral path near the top element is larger than a radius of the spiral path near a bottom of the elongated body.

### BACKGROUND OF THE INVENTION

Dental implants are expected to be implanted in a bone of a patient and to interface between the bone and an artificial crown.

Forces that are applied on the artificial crown are converted by various prior art implants to sheer stress forces that may damage bone and prevent or mitigate the fusion of the bone to the dental implant.

There is a growing need to provide improved dental implants that will reduce the negative impact of shear stress on the bone.

### SUMMARY

According to an embodiment of the invention a dental implant is provided and may include: (A) a top element that is substantially horizontal and is positioned at a top of the dental implant; (B) an elongated body that has a longitudinal axis and is connected to the elongated body; wherein an outer edge of the top element is more distant from the longitudinal axis that any outer edge of the elongated body; and (C) at least one structural element, connected to the elongated body, wherein that at least one structural element defines a substantially spiral path outside of the elongated body; wherein a radius of the substantially spiral path near the top element is larger than a radius of the spiral path near a bottom of the elongated body. The at least one structural element define a spiral path in the sense that they can form a substantially spiral path (for example- by having a substantially spiral shape) or by being confined to a virtual space that is substantially spiral.

According to another embodiment of the invention a dental implant is provided and may include: (a) an elongated body; (b) a top element that is arranged to be on top of an upper portion of a bone when a lower portion of the elongated body is implanted in the bone; wherein the elongated body has a longitudinal axis and is connected to the elongated body; wherein an outer edge of the top element is more distant from the longitudinal axis that any outer edge of the elongated body; and (c) at least one structural element, connected to the elongated body, wherein that at least one structural element defines a substantially spiral path outside of the elongated body; wherein a radius of the substantially spiral path near the top element is larger than a radius of the spiral path near a bottom of the elongated body.

In any of the mentioned above embodiments the top element may be shaped so facilitate direct contact with an external portion of a bone, when the dental implant is implanted in the bone.

In any of the mentioned above embodiments the top element may be perpendicular to the longitudinal axis.

In any of the mentioned above embodiments the outer edge of the top element may be more distant from the longitudinal axis that any outer edge of any of the at least one structural elements.

In any of the mentioned above embodiments the top element may be shaped as a ring.

In any of the mentioned above embodiments the outer edge of the ring may be more distant from the longitudinal axis that any of the at least one structural elements.

In any of the mentioned above embodiments the top element may include multiple segments that are spaced apart from each other.

In any of the mentioned embodiments at least a portion of an outer edge of a structural element may be more distant from the longitudinal axis than at least a portion of an outer edge of the top element.

In any of the mentioned above embodiments the at least one structural element may include multiple structural elements.

In any of the mentioned above embodiments the multiple structural elements may be connected to each other.

In any of the mentioned above embodiments the multiple structural elements may be spaced apart from each other.

In any of the mentioned above embodiments the at least one structural element may be a single structural element.

In any of the mentioned above embodiments the at least one structural element may define a spiral path outside of the elongated body.

In any of the mentioned above embodiments the radius of the substantially spiral path may monotonically decrease with an increase of a distance from the top element.

In any of the mentioned above embodiments the at least one structural element may include at least one aperture.

In any of the mentioned above embodiments the elongated body may be cylindrical.

In any of the mentioned above embodiments the elongated body may have a conical shape.

In any of the mentioned above embodiments the top element may be spaced apart from any of the at least one structural elements.

In any of the mentioned above embodiments the top element may be proximate to a highest end of the at least one structural elements.

In any of the mentioned above embodiments the top element and the elongated body may be integrated to each other.

In any of the mentioned above embodiments the top element and at the at least one structural element may be shaped such as to convert stresses applied on the dental implant to compressing forces applied on the bone.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a three dimensional view of a dental implant according to an embodiment of the invention;

FIG. 2 is a cross sectional view of a dental implant and further illustrates structural elements that extend outside the elongated body of the dental element according to an embodiment of the invention;

FIG. 3 is a cross sectional view of a dental implant and further illustrates structural elements that extend outside the elongated body of the dental element according to an embodiment of the invention;

FIG. 4 is a cross sectional view of a dental implant and further illustrates forces that are applied on the dental implant and by the dental implant according to an embodiment of the invention;

FIG. 5 is a cross sectional view of a dental implant and of a bone in which the dental implant is implanted according to an embodiment of the invention;

FIG. 6 is a cross sectional view of a dental implant according to another embodiment of the invention; and

FIG. 7 is a top view of an elongated body according to another embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The term “top” has its regular meaning and also refers to the side that is more distant to the jaw (when the dental implant is implanted). A top element can be referred to as a proximal element.

An outer edge of an object (top element, elongated body, structural element) is an edge that is the most distant edge in relation to the longitudinal axis.

There is provided a dental implant that may maximize normal-compressive stresses along the dental implant and especially in the cervical area of the implant.

The suggested dental implant is supposed to enable effective mechanical bone adaptation with minimal deterioration of the bone nearby the dental implant.

According to an embodiment of the invention a dental implant is provided. It may include (a) a top element that is substantially horizontal and is positioned at a top of the dental implant; (b) an elongated body that has a longitudinal axis and is connected to the elongated body; wherein an outer edge of the top element is more distant from the longitudinal axis that any outer edge of the elongated body; and (c) at least one structural element, connected to the elongated body, wherein that at least one structural element defines a substantially spiral path outside of the elongated body; wherein a radius of the substantially spiral path near the top element is larger than a radius of the spiral path near a bottom of the elongated body.

The at least one structural elements can define a spiral path that includes multiple windings. The upper windings can be wider than the lower windings or other wise cover (from a top view) a larger area.

Non-overlapping coverage areas between different windings can apply compression forces on the adjacent bone.

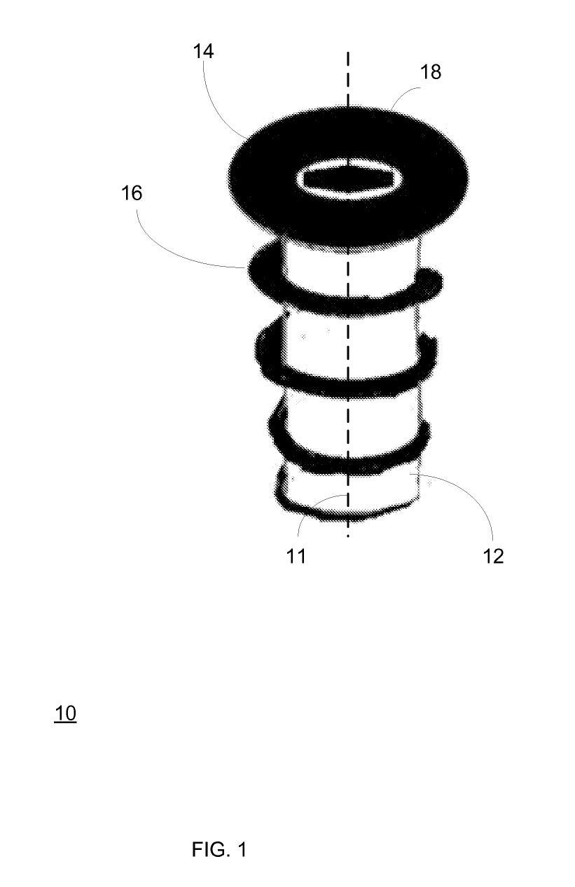

FIGS. 1-5 illustrate a dental implant 10 in which the elongated body 12 has a cylindrical shape and has a vertical longitudinal axis, the top element 14 is a horizontal ring and the at least one structural element 16 is a single structural element 16 that forms a spiral path in which its radius monotonically decreases with distance from the top element. The elongated body 12 has an outer edge 12(1). The top element 14 has an outer edge 14(1). The at least one structural element has an outer edge 16(1).

FIGS. 1-5 also illustrates that the top element 14 is spaced apart from the single structural element 16, that from a top view the top element 14 “covers” a wider area than the single structural element 16 and that the single structural element is s continuous strip that is extends radially from the elongated body 12.

The top element 14 may be shaped so facilitate direct contact with an external portion of a bone, when the dental implant is implanted in the bone.

It is noted that FIGS. 1-5 provide a non-limiting example of the dental implant 10 and that various variations can be provided.

For example, according to various embodiments of the invention the top element 14 may:
a. be slightly tilted in relation to the horizon,
b. have a curved (or otherwise non-linear) cross section,
c. have a shape that differs from a ring,
d. include segments that are spaced apart from each other (for example it may include multiple segments that are radially aligned),
e. have an elliptical shape,
f. narrower (from a top view) from at least one portion of the at least one structural elements (so that from a top view at least a part of the at least one structural element may extend outside the area covered by the top element),
g. be a grid,
h. include a grid or a mesh,
i. include one or more apertures,
j. have an aperture (18) for allowing the elongated body to interface with the artificial crown or an interfacing element that in turn interfaces between the elongated body and the artificial crown,
k. be spaced apart from any of the at least one structural elements,
l. be proximate to a highest end of the at least one structural elements,
m. integrated with the top element.
n. made of the same material as the elongated body,
o. made from a different material than the elongated body.

According to various embodiments of the invention the at least one structural element 16 may:
a. include multiple structural element,
b. include multiple structural elements that are equal to each other,
c. include multiple structural elements, wherein at least two of the multiple structural elements may differ from each other by size,
d. include multiple structural elements, wherein at least two of the multiple structural elements may differ from each other by shape,
e. include multiple structural elements that include at least two structural elements that are spaced apart from each other,
f. be a grid,
g. include a grid or a mesh,
h. include one or more apertures,
i. define a perfect spiral path.
j. define a path that slightly differs from a spiral path,
k. define a path in which the radius of the substantially spiral path monotonically decreases with an increase of a distance from the top element,
l. define a path in which the radius of the substantially spiral path decreases in a non-monotone manner with an increase of a distance from the top element,
m. define a path in which the radius of the substantially spiral path monotonically increases with an increase of a distance from the top element,
n. define a path in which the radius of the substantially spiral path increases in a non-monotone manner with an increase of a distance from the top element,
o. define a path in which the radius of the substantially spiral path changes such as to include at least one increment and at least one decrement,
p. include anti-rotational elements such as perturbations, spikes or other structural elements that reduce the chances of a rotation of the elongated body about its longitudinal axis.

For example, according to various embodiments of the elongated body 12 may:
a. have a cylindrical shape,
b. have a conical shape,
c. have a polygonal shape,
d. have rotational symmetry,
e. be asymmetrical,
f. be smooth,
g. have a rough outer edge,
h. be hollow,
i. includes an interface for receiving the artificial crown or any interfacing element for interfacing between the artificial crown and the elongated body,
j. include anti-rotational elements such as perturbations, spikes or other structural elements that reduce the chances of a rotation of the elongated body about its longitudinal axis.

The top element, once implanted, seats over the bone and compress the upper area of the bone. This area is the most vulnerable area of the bone that is attached to implants because of shear stress.

FIGS. 1-6 also show a space 18 formed in the elongated body. The space 18 acts as an interface between the elongated body 12 and either an artificial crown or another interfacing element (such as an abutment) that in turn interfaces between the elongated body and the artificial crown.

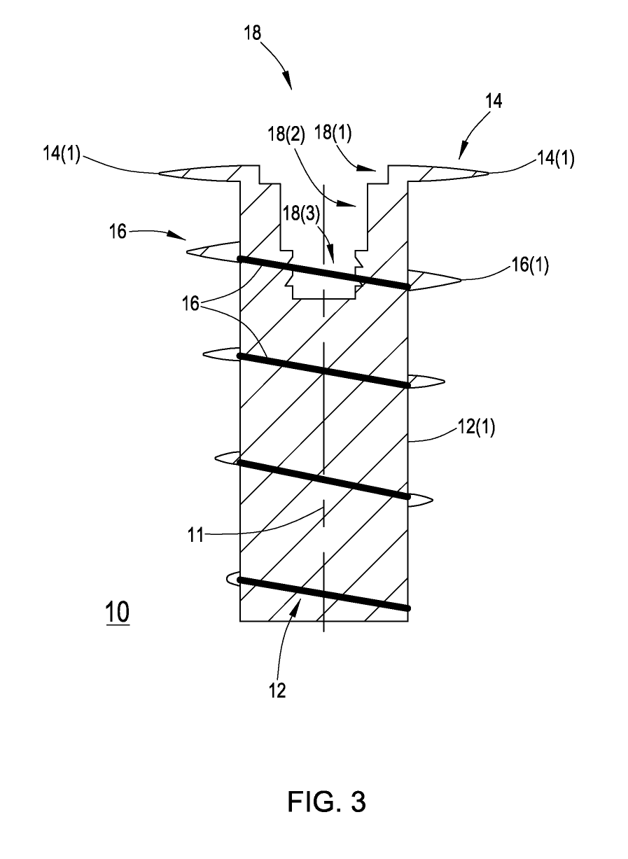

FIG. 3 illustrates space 18 that starts by a top cylindrical space 18(1), an intermediate cylindrical space 18(2) (having a smaller radius than the top cylindrical space) and a bottom space (3) that has a threaded shape for securing a screw.

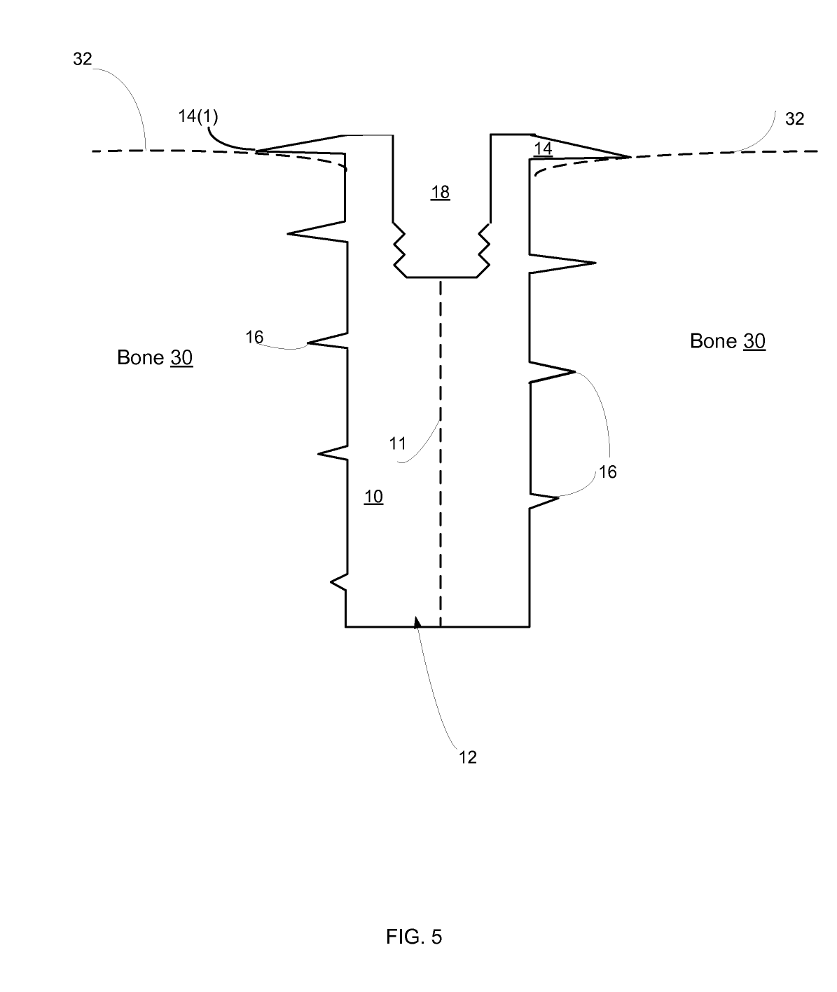

FIG. 5 illustrates the dental implant 10 that is implanted in a bone 30 while the top element 14 of the dental implant 10 is located above the upper part (represented by dashed arrows 32) of bone 32, while contacting that upper part 32.

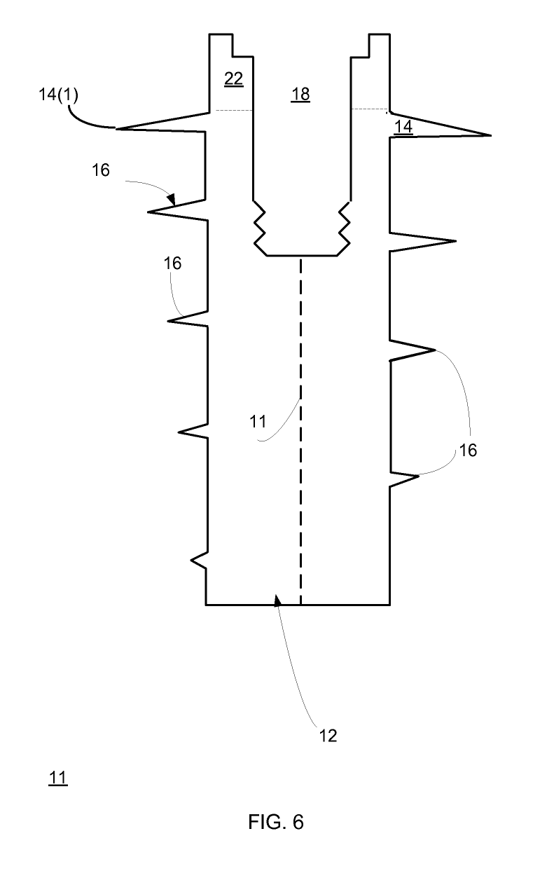

FIGS. 1-4 illustrate the top element 14 as being the upmost portion of the dental implant 10, while FIG. 6 illustrates at upmost element 22 that is located above the top element 14.

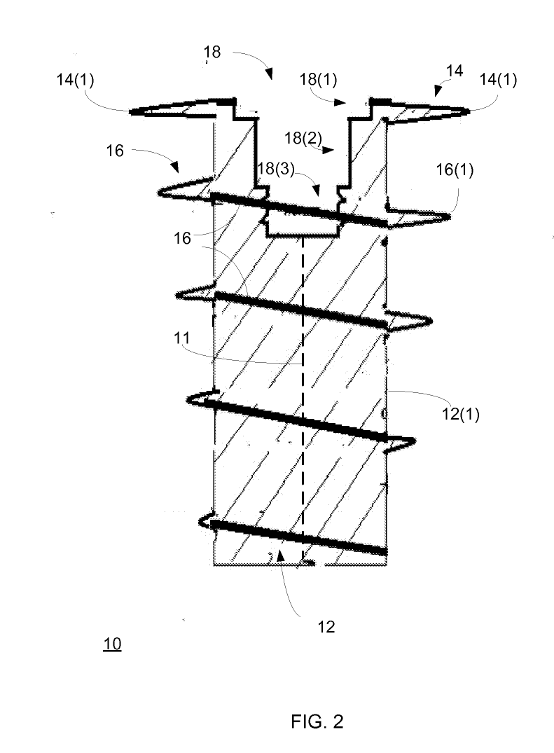

FIG. 2 illustrates non-limiting example of the dimensions of dental implant 10.

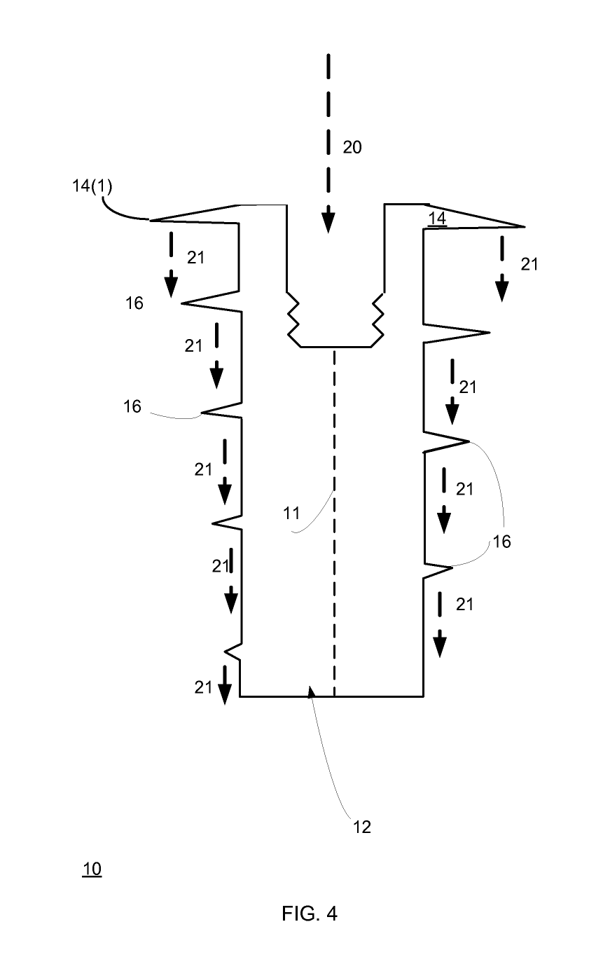

FIG. 4 illustrates a vertical force 20 that applied on the dental implant 10 is converted to compression forces 21 applied on the bone in which the dental implant 10 is implanted.

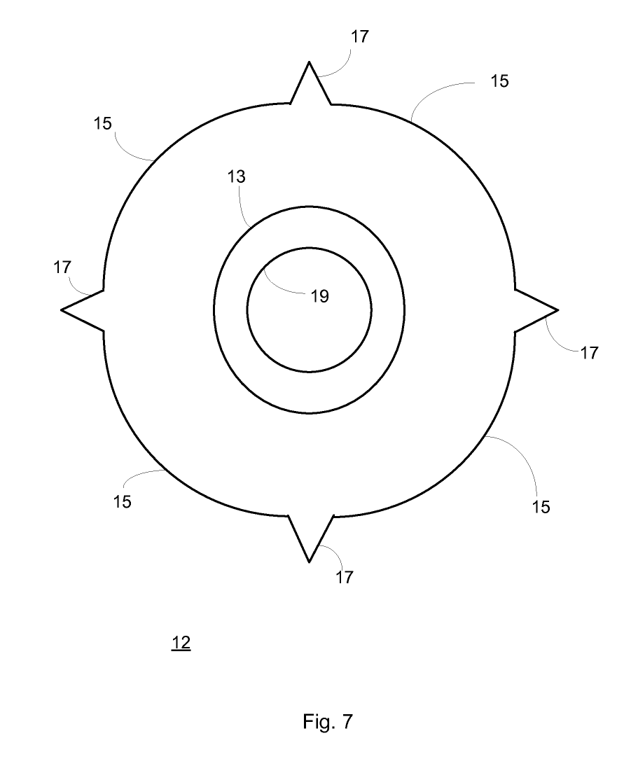

FIG. 7 is a top view of the elongated body 12 according to an embodiment of the invention. The elongated body 12 has (a) curved external portions 15 that substantially form a virtual circle, (b) spikes 17 that extend outside of the virtual circle and have an anti-rotational affect, (c) rings 13 and 19 that form a space (such as space 18 of previous figures).

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A dental implant, comprising:
an elongated body;
a top element that is arranged to be on top of an upper portion of a bone when a lower portion of the elongated body is implanted in the bone;
wherein the elongated body has a longitudinal axis and is connected to the top portion; wherein an outer edge of the top element is more distant from the longitudinal axis that any outer edge of the elongated body;
at least one structural element, connected to the elongated body, wherein that at least one structural element defines a substantially spiral path outside of the elongated body;
wherein a radius of the substantially spiral path monotonically decreases with an increase of a distance from the top element. than a radius of the spiral path near a bottom of the elongated body.

2. The dental implant according to claim 1, wherein when the top element is located above the elongated body.

3. The dental implant according to claim 1, wherein the top element is perpendicular to the longitudinal axis.

4. The dental implant according to claim 1, wherein the outer edge of the top element is more distant from the longitudinal axis that any outer edge of any of the at least one structural elements.

5. The dental implant according to claim 1, wherein the top element is shaped as a ring.

6. The dental implant according to claim 5, wherein an outer edge of the ring is more distant from the longitudinal axis that any of the at least one structural elements.

7. The dental implant according to claim 1, wherein the top element comprises multiple segments that are spaced apart from each other.

8. The dental implant according to claim 1, wherein the elongated body comprises spikes that extend outside a virtual circle formed by curved external portions of the elongated body.

9. The dental implant according to claim 1, wherein the at least one structural element comprise multiple structural elements.

10. The dental implant according to claim 9, wherein the multiple structural elements are connected to each other.

11. The dental implant according to claim 9, wherein the multiple structural elements are spaced apart from each other.

12. The dental implant according to claim 1, wherein the at least one structural element is a single structural element.

13. The dental implant according to claim 1, wherein the at least one structural element defines a spiral path outside of the elongated body.

14. The dental implant according to claim 1, wherein a diameter of the top element is 4.2 millimeter, and a length of the dental implant is 10 millimeters.

15. The dental implant according to claim 1, wherein at least one structural element comprises at least one aperture.

16. The dental implant according to claim 1, wherein the elongated body is cylindrical.

17. The dental implant according to claim 1, wherein the elongated body has a conical shape.

18. The dental implant according to claim 1, wherein the top element is spaced apart from any of the at least one structural elements.

19. The dental implant according to claim 1, wherein the top element is proximate to a highest end of the at least one structural elements.

20. The dental implant according to claim 1, wherein the top element and the elongated body are integrated.

21. The dental implant according to claim 1, wherein the top element and at of the structural elements are shaped such as to convert stresses applied on the dental implant to compressing forces applied on the bone.

22. The dental implant according to claim 1, wherein comprising an upmost element that is positioned above the top element.

23. A dental implant, comprising:
a top element that is substantially horizontal and is positioned at a top of the dental implant; wherein the top element includes a mesh or a grid;
an elongated body that has a longitudinal axis and is connected to the elongated body; wherein an outer edge of the top element is more distant from the longitudinal axis that any outer edge of the elongated body;
at least one structural element, connected to the elongated body, wherein that at least one structural element defines a substantially spiral path outside of the elongated body; wherein a radius of the substantially spiral path near the top element is larger than a radius of the spiral path near a bottom of the elongated body.
